(19) United States
(12) Patent Application Publication
(10) Pub. No.: US 2011/0071725 A1
(43) Pub. Date: Mar. 24, 2011

(54) REMOTELY INTERACTING WITH A VEHICLE TO PERFORM SERVICING AND ENGINEERING FUNCTIONS FROM A NOMADIC DEVICE OR COMPUTER

(75) Inventors: Robert Bruce Kleve, Farmington, MI (US); John Robert Van Wiemeersch, Novi, MI (US)

(73) Assignee: FORD GLOBAL TECHNOLOGIES, LLC, Dearborn, MI (US)

(21) Appl. No.: 12/565,214

(22) Filed: Sep. 23, 2009

(51) Int. Cl. G06F 7/00

(52) U.S. Cl. 701/33

(57) ABSTRACT

A method for remotely performing vehicle service functions may include receiving at a computer a request signal including at least one instruction for diagnosing a vehicle component. The method may also include retrieving one or more threshold parameters stored for determining a diagnosis of the vehicle component. A diagnostic signal together with the threshold parameters and the diagnostic instruction may be transmitted to a vehicle receiver. The determination as to whether the threshold parameters have been met is made at a vehicle. If the one or more threshold parameters are met, a return signal including diagnostic status identifiers identifying a diagnostic status of the vehicle component may be received. A message including at least one diagnostic status of the vehicle component based on the one or more diagnostic status identifiers may generated and displayed on a graphical display for vehicle diagnosis and service.

### BACKGROUND

1. Technical Field

One or more embodiments include a method and system for remotely executing service and engineering functions from a nomadic device or computer.

2. Background

It is generally recommended that a vehicle owner routinely service his or her vehicle in order to maximize the vehicle's life span. Occasionally, however, it may be difficult or inconvenient for the owner to obtain a servicing. For example, if the owner is travelling, and the vehicle has a problem, the vehicle owner may not know of the nearest service shop or dealership or may be in a location with no service shop or dealership nearby. Alternatively, the service shop may not have any immediate appointments for servicing of particular problems, but the owner is concerned about the problems nevertheless and would like them addressed.

Additionally, original equipment manufacturers (OEMs) such as vehicle manufacturers test vehicles before the vehicles are released to the market. Some components of the vehicle generally require a manual inspection of each vehicle. This can lead to high costs for the OEM due to each manual inspection and slower turn around time for release to the market.

### SUMMARY

One aspect includes a computer-implemented method for remotely performing one or more vehicle service functions. The method may include receiving at a computer a request signal including at least one instruction for performing a diagnosis of one or more vehicle components.

The method may further include retrieving one or more threshold parameters for determining a diagnosis of the one or more vehicle components. In one embodiment, the one or more threshold parameters may be user-defined. In an additional embodiment, the threshold parameter relates to a vehicle engine. Furthermore, in an additional embodiment, the threshold parameter relates to a temperature of a vehicle or the one or more vehicle components.

The method may further include transmitting a diagnostic signal to a vehicle receiver together with the one or more threshold parameters and the at least one diagnostic instruction. A determination as to whether the one or more threshold parameters have been met may be made at a vehicle.

The method may further include receiving at least one return signal if the one or more threshold parameters have been met. The return signal may include one or more diagnostic status identifiers identifying a diagnostic status of the one or more vehicle components. In one embodiment, the at least one diagnostic instruction may include at least one instruction for receiving diagnostic trouble codes. Accordingly, the one or more diagnostic status identifiers are one or more diagnostic trouble codes. The diagnostic trouble codes may include non-standardized codes.

The method may further include generating a message including at least one diagnostic status of the one or more vehicle components based on the one or more diagnostic status identifiers. The method may additionally include displaying the message on a graphical for vehicle diagnosis and service.

The method may further include, in one embodiment, receiving vehicle component usage data based on the one or more diagnostic status identifiers. The method may further include determining a usage of the one or more vehicle components based on the vehicle component usage data. Additionally, one or more customer vehicle usage profiles based on the vehicle usage data may be generated.

In an additional embodiment, the method may include retrieving warranty information for one or more vehicles. The method may also include determining if the one or more vehicles is under warranty and, based on the determination, displaying a warranty status with the message.

Another aspect includes a cellular communication module within a vehicle for remotely performing one or more vehicle service functions. The cellular communication module may be configured to receive at least one diagnostic signal. The diagnostic signal may include one or more threshold parameters and at least one instruction for determining a diagnosis of one or more vehicle components.

The cellular communication module may be further configured to communicate with a vehicle data bus to monitor for when the one or more threshold parameters are met. The cellular communication module may also be configured to capture one or more diagnostic status identifiers if the one or more threshold parameters are met. In one embodiment, the one or more diagnostic status identifiers are one or more diagnostic trouble codes.

The cellular communication module may be further configured to determine a diagnostic status based on the one or more diagnostic status identifiers. The cellular communication module may be further configured to transmit a diagnostic status signal based on the diagnostic status to a remote terminal for vehicle diagnosis and service.

In one embodiment, the cellular communication module may be configured to determine the diagnosis while a vehicle is travelling. In this embodiment, the threshold parameter may relate to a speed of the vehicle.

In one embodiment, the threshold parameter may additionally relate to atmospheric temperature.

The cellular communication module may be further configured to retrieve additional diagnostic status identifiers, correlate the captured diagnostic status identifiers with the additional diagnostic status identifiers, and determine the diagnostic status based on the correlation. The correlation may generate a diagnostic status capable of being displayed on the remote terminal. The remote terminal may be a nomadic device or personal computer.

Another aspect may include a computer-implemented method for remotely performing one or more vehicle service functions. The method may include receiving at least one diagnostic signal including one or more threshold parameters and at least one instruction for determining a diagnosis of one or more vehicle components. The method may further include communicating with a vehicle data bus to monitor for when the one or more threshold parameters are met. Additionally, if the one or more threshold parameters are met, the method may further include capturing one or more diagnostic status identifiers. The method may additionally include determining a diagnostic status based on the one or more diagnostic status identifiers. The method may further include transmitting a diagnostic status signal based on the diagnostic status to a remote terminal for vehicle diagnosis and service. In one embodiment, the method may include determining the diagnostic status while a vehicle is travelling.

These and other aspects of the present invention will be better understood in view of the attached drawings and following detailed description of the invention.

### BRIEF DESCRIPTION OF THE DRAWINGS

The figures identified below are illustrative of some embodiments of the present invention. The figures are not intended to be limiting of the invention recited in the appended claims. Embodiments of the present invention, both as to their organization and manner of operation, together with further object and advantages thereof, may best be understood with reference to the following description, taken in connection with the accompanying drawings, in which:

FIG. 1 shows an illustrative example of a communication system through which a nomadic device can communicate with a vehicle according to one of the various embodiments;

FIGS. 2a-d show illustrative examples of vehicle-based communication modules that provide communication to a remote network according to one of the various embodiments;

FIG. 3 illustrates a non-limiting exemplary operation of the vehicle-based communication module according to one of the various embodiments;

FIG. 4 illustrates one of the various embodiments of the operation for remotely interacting with a vehicle to perform real-time servicing and engineering functions from a nomadic device or computer.

### DETAILED DESCRIPTION

Detailed embodiments of the present invention are disclosed herein. However, it is to be understood that the disclosed embodiments are merely exemplary of an invention that may be embodied in various and alternative forms. Therefore, specific functional details disclosed herein are not to be interpreted as limiting, but merely as a representative basis for the claims and/or as a representative basis for teaching one skilled in the art to variously employ the present invention.

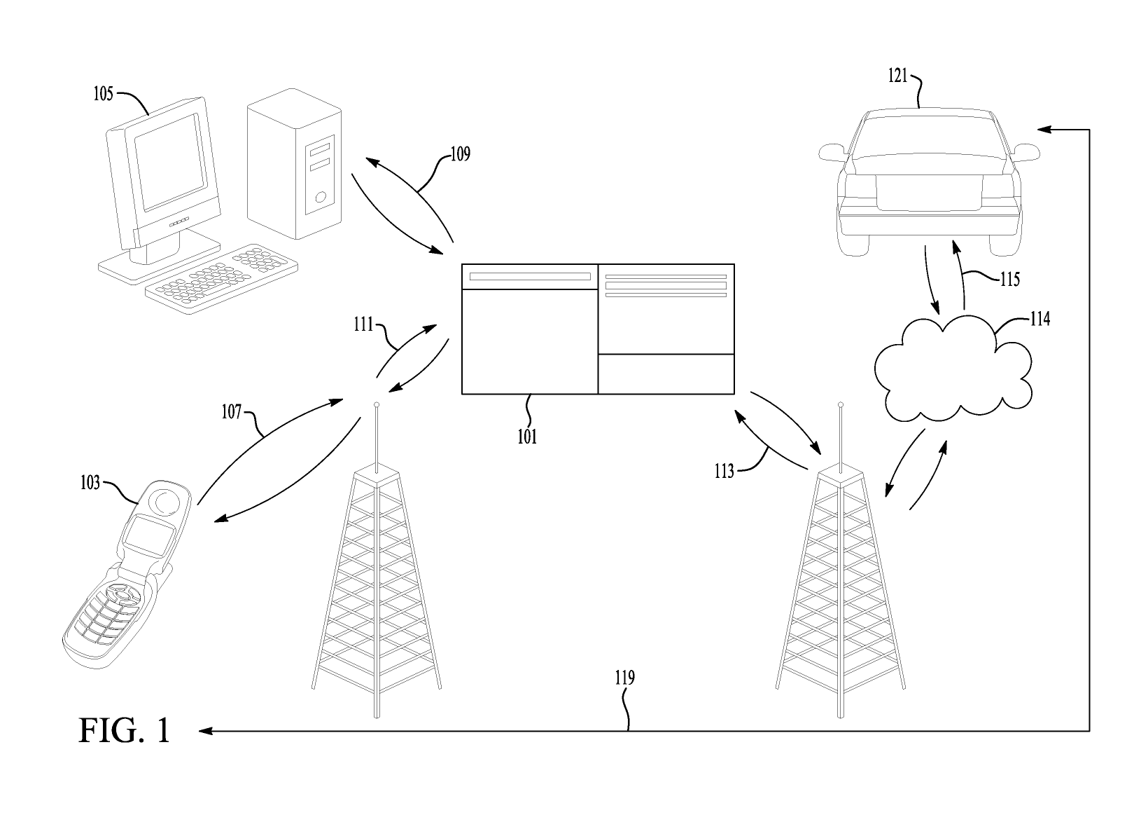

FIG. 1 shows an illustrative example of a communication system through which a nomadic device can communicate with a vehicle. In this illustrative embodiment, a nomadic device (e.g., without limitation, a cellular phone) 103 is used to send a communication through a cellular network 107. This communication is relayed through a network 111 (e.g., without limitation, the cellular network, the internet, etc.) to a centralized system 101. A system similar to the system shown in FIG. 1 is available from CRAYON INTERFACE, INC.

In this illustrative embodiment, the centralized system is a server system that includes processing capability for incoming nomadic device signals designated to interact with a remote vehicle 121.

For example, the server(s) 101 may include an automated call server and/or web host. Further, the server(s) may route an incoming signal from a nomadic device (ND) 103 to the appropriate remote vehicle. Data sent in this fashion may be sent using data-over-voice, a data-plan, or in any other suitable format.

Data can also be sent to the remote vehicle through the server(s) using a personal computer 105. In this case, the data is likely, although not necessarily, sent over the internet 109.

Once the server(s) receive the incoming data request from the remote source 103, 105, the message is processed and/or relayed to a vehicle. The vehicle may be identified by a header associated with one or more incoming data packets, or may be identifiable based on a database lookup, for example.

The relay to the vehicle is sent out from the server(s) 101 through a network (e.g., without limitation, a cellular network 113, the internet, etc.) and passed through a cellular network 115 to the vehicle 121. In one embodiment, the relay may additionally be passed through a broadband network 114 (e.g., 802.11g or WiMax). A remote communication module 200 in the vehicle receives the signal sent from the servers and processes it or relays it to an appropriate processing system within the vehicle.

In at least one illustrative embodiment, the vehicle is also outfitted with a backup communication transceiver, such as, but not limited to, a BLUETOOTH transceiver. This transceiver may allow communication with the nomadic device 103 using a direct signal 119 if, for example, cellular networks are unavailable.

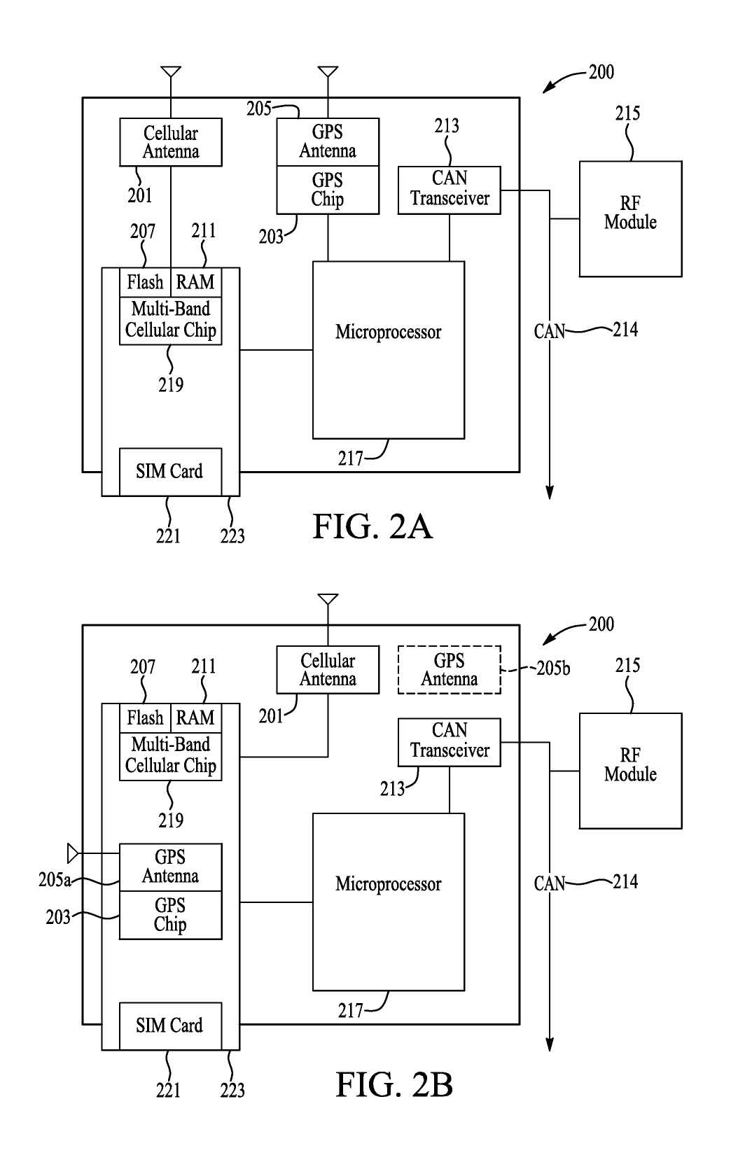

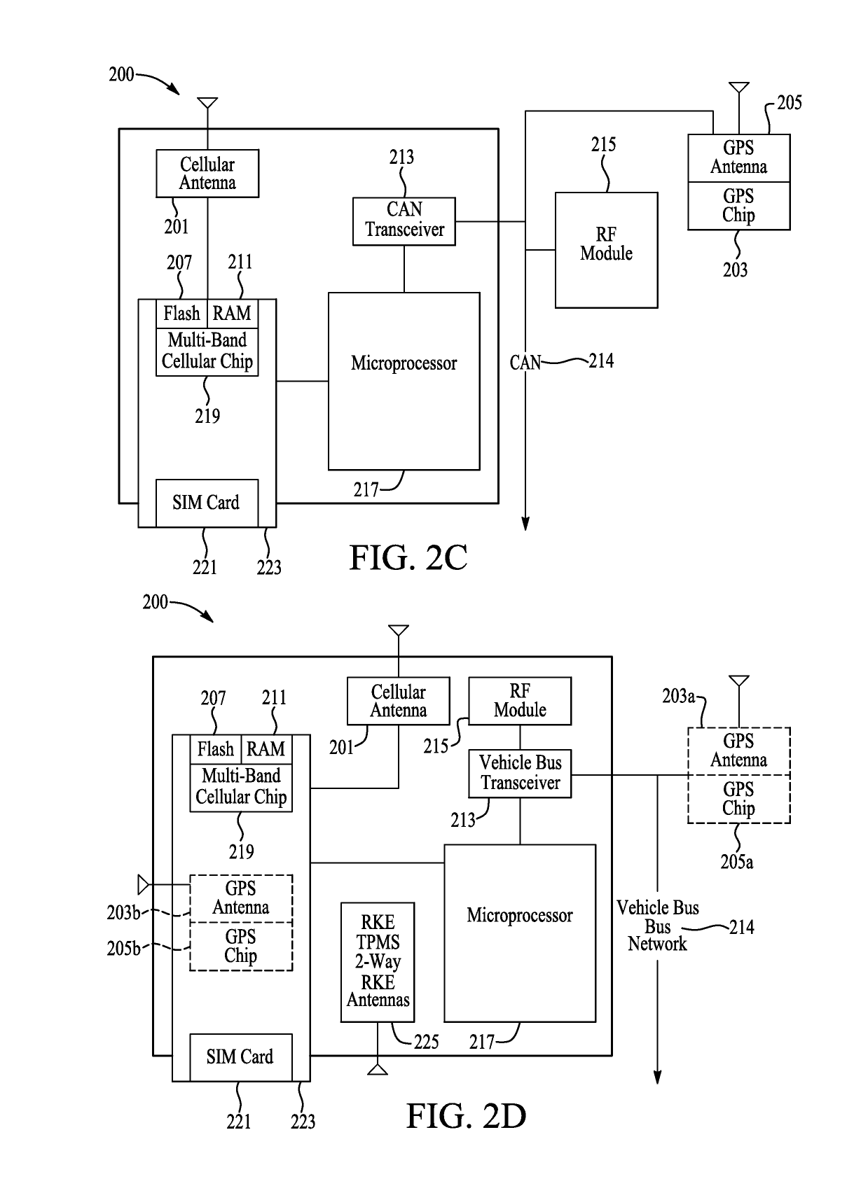

FIGS. 2a-d show illustrative examples of vehicle-based communication modules that provide communication to a remote network.

FIG. 2a shows an illustrative example of a communication module combined with a GPS module, wherein a cellular module and GPS are on different boards.

In this illustrative embodiment, a communications module 200 can include a cellular (e.g., and without limitation, GSM or CDMA) antenna 201 that communicates with a remote server over a cellular network. The received cellular signal may be sent from the cellular antenna 201 to a multi-band cellular (e.g., and without limitation, GSM or CDMA) decoder 219 that processes the received signal to produce information usable by the microprocessor 217.

In this illustrative embodiment, the multi-band cellular chip 219, including flash memory 207 and RAM 211, is installed in the module as part of a removable device 223 including a SIM card 221. The SIM card may contain user identifying information that allows access to the cellular network under a particular user's plan.

Additionally, the module includes a GPS chip 203 that can process and decode a signal from the GPS antenna 205 and send this information to a microprocessor 217.

The microprocessor 217 is also in communication with a vehicle data bus that provides access to various vehicle modules, such as a RF module 215. Other modules not shown include, but are not limited to, the vehicle cluster, a remote (off-board) GPS system, a radio module, etc. Non-limiting examples of a vehicle data bus include an SAE J1850 bus, a CAN bus, a GMLAN bus, and any other vehicle data buses known in the art. For illustration purposes only, FIGS. 2a-2d are represented as using a CAN bus.

FIG. 2b shows a second exemplary embodiment in which a cellular module and GPS are on the same board 223. In this illustrative embodiment, the removable board (this board may also be permanently attached to the module) 223 may contain the SIM card 221, a GPS module including a GPS chip 203 and a GPS antenna 205a, and the Multi-band cellular chip 219 including flash memory 207 and RAM 211.

In another embodiment, the GPS antenna 205b may be attached to the module separately from this board 223. When a signal comes in from the cellular antenna and/or the GPS Antenna 205b, the signal may be sent to the corresponding cellular/GPS chip for processing, and then passed to the microprocessor 217. The microprocessor interfaces with the CAN transceiver 213 to connect to a vehicle network 214 and vehicle modules such as a RF module 215.

FIG. 2c shows yet another exemplary embodiment in which the cellular module is standalone. In this illustrative embodiment, the GPS module containing the GPS antenna 205 and the GPS chip 203 may connect to the microprocessor 217 through the CAN transceiver 213. Other vehicle modules, such as an RF module 215 can also connect to the microprocessor through the CAN transceiver 213.

In this illustrative embodiment, the removable board 223 may contain a SIM card 221 and a multi-band cellular chip 219, as well as a flash memory 207 and RAM 211. Signals from the cellular antenna 201 may be sent to the board 223 for processing by the multi-band cellular chip 219 before being sent to the microprocessor 217.

FIG. 2d shows still another exemplary embodiment in which a cellular module is combined with an RF module 215 in the communications module 200. The RF module 215 may continue to talk to the microprocessor 217 through the CAN transceiver 213. In this illustrative embodiment, the GPS module, including the GPS antenna 203a, 203b and GPS chip 205a, 205b can be located within the communications module 200 or located elsewhere in the vehicle, in which case it may communicate with the microprocessor 217 through the CAN transceiver 213.

Again, in this embodiment, the cellular antenna 201 may send a signal to the multi-band cellular chip 219, including flash memory 207 and RAM 211. The signal may be processed and sent to the microprocessor 217. The multi-band cellular chip 219 may be located on a removable circuit board 223, which may also include a SIM card 221.

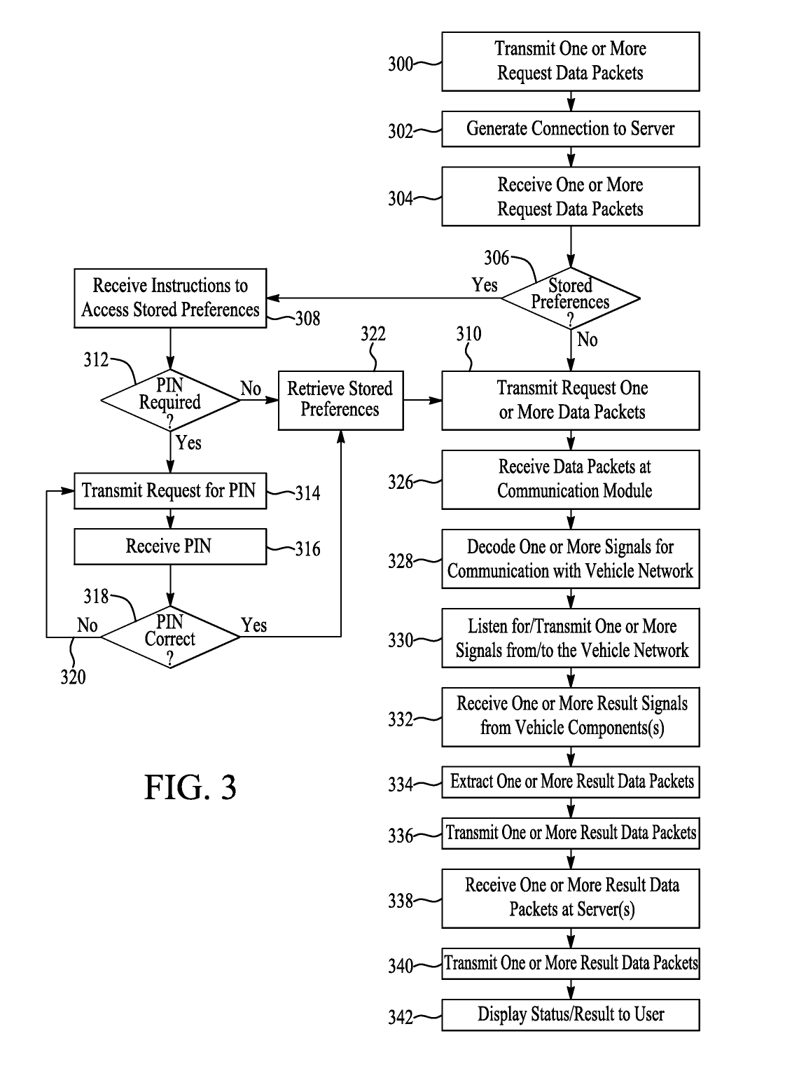

FIG. 3 illustrates the operation of the communication module 200 according to one of the various embodiments. It should be understood that the ND 103 and/or computer 105 may include software for facilitating the operation of the one or more embodiments. The software may be downloaded to the ND 103 or computer 105 from a website (such as an OEM's website) or, as another example, come factory installed in the ND. One example of a website is SyncMyRide.com hosted by The Ford Motor Company. In one embodiment, the software may be a programmed in the JAVA language (manufactured and distributed by Sun Microsystems).

In one or more embodiments, a user may control one vehicle with multiple NDs 103 or computers 105. Additionally or alternatively, the user may use one ND 103 or computer 105 to operate components of multiple vehicles.

According to one or more embodiments, various service and engineering functions may be accomplished dynamically or statically. For example, some vehicle manufacturers provide a technical hotline which can be used by a vehicle owner or dealership for answering technical issues with a vehicle. Accordingly, the hotline may be able to access vehicle information and diagnose one or more vehicle issues. Further details of this operation will be described below.

As another non-limiting example, calibration updates may be accessible by a user from a home computer or to a dealership computer using one or more embodiments as described below. Calibration updates may be streamed to the user over a wireless link. Accordingly, in at least one way, a vehicle-owner, for example, may then avoid visiting a dealership.

The user (e.g., without limitation, a service technician, a vehicle owner, one or more members of an engineering team, or one or more members of a product development team) may activate and operate the software using one or more button or key presses from his or her ND 103 and/or computer 105. In one embodiment, the ND 103 and/or computer 105 may be equipped with a shortkey or “hot button” from which the software may be activated. Alternatively or additionally, the user may activate and operate the software through a menu selection from a graphical user interface (GUI) displayed on the ND 103 and/or computer 105.

Alternatively or additionally, the user may operate and activate the software through one or more voice-activated commands received by the ND 103 and/or computer 105. The ND 103 and/or computer 105 may include speech recognition software for interpreting and processing commands from a user into machine readable language. In one embodiment, the speech recognition software may be programmed and/or stored to the web server. Non-limiting examples of a user may be a vehicle owner, a vehicle passenger, a vehicle service technician, or a vehicle dealer.

Upon making the request (via, e.g., key button press or voice), one or more data packets may be transmitted from the ND 103 or computer 105 as illustrated in block 300. Non-limiting examples of data (i.e., information) transmitted in the data packets may include a mobile identification number (MIN), a customer identification number, instructions and parameters for accomplishing the one or more commands sent from the ND 103 and/or computer 105, and the vehicle identification number (VIN).

Using one or more embodiments, a user may be able collect customer usage profiles that may be used for feedback to, for example, an OEM's engineering department. Customer usage profiles may include, but is not limited to, information on catalyst temperatures to, in at least one embodiment, improve estimates of customer usage. Other non-limiting examples of information that may be included in a customer usage profile are completion rates of the on-board diagnostics (OBD) II monitor, a measure of driver aggressiveness (i.e., throttle usage) and acceleration.

In additional non-limiting embodiments, a user may use one or more embodiments to collect early warranty information using, for example, diagnostic codes collected from the vehicle. This may give the user diagnostics on one or more vehicle components including those components that do not have a warning lamp or message center warning associated with it. Accordingly, diagnostic codes may include standardized and non-standardized codes. In one embodiment, standardized codes may include fault codes defined by the Society of Automotive Engineers and generally referred to as “SAE Diagnostic Trouble Codes.” Non-standardized codes may include, but are not limited to, codes determined by an original equipment manufacturer.

Referring back to FIG. 3, before or after the data packets are transmitted, a connection may be generated with the server(s) 101 as illustrated in block 302. The server(s) 101 may or may not be a web server. Once a connection to sever(s) 101 is made, the data packets may be received by the server(s) 101 as illustrated in block 304. Alternatively or additionally, a direct connection may be made between the ND 103 or computer 105 and the cellular communication module 200 (i.e., without making a connection to server(s) 101). Accordingly, the operation of one or more embodiments of the present invention may be accomplished without a server.

The server(s) 101 may process one or more received commands for transmission to the vehicle 121. Processing the data packet may include, but is not limited to, authenticating the one or more commands, authenticating the user (e.g., determining if the user is a registered user) and authenticating the cellular/mobile phone (e.g., matching the MIN to the VIN) transmitted in the data packet. In one non-limiting embodiment, the server(s) 101 may process the data packet using one or more look-up tables and validating the information in the data packets against the one or more tables. The server(s) 101 may include software containing computer-executable instructions for accomplishing one or more embodiments.

In some embodiments, processing may additionally or alternatively occur at the ND 103 and/or computer 105. In some further embodiments, the processing may occur in the cellular communication module 200 (for example and without limitation at the microprocessor 217).

The server(s) 101 may be in further communication with one or more databases (not shown). Non-limiting examples of information that may be stored in the one or more databases may include vehicle warranty information, vehicle diagnostic trouble codes (DTC), customer information, previous customer usage profiles (non-limiting examples include catalyst temperatures and OBD II monitor completion rates), software updates, and vehicle information. The data may be retrieved from third-party systems, OEM (e.g., vehicle) databases/servers or manually inputted by a user (e.g., an OEM).

Other non-limiting data that may be stored in the database may include testing parameters for diagnosing one or more vehicle components. The testing parameters may be criteria for identifying which vehicle component(s) to test and when to test the vehicle component(s).

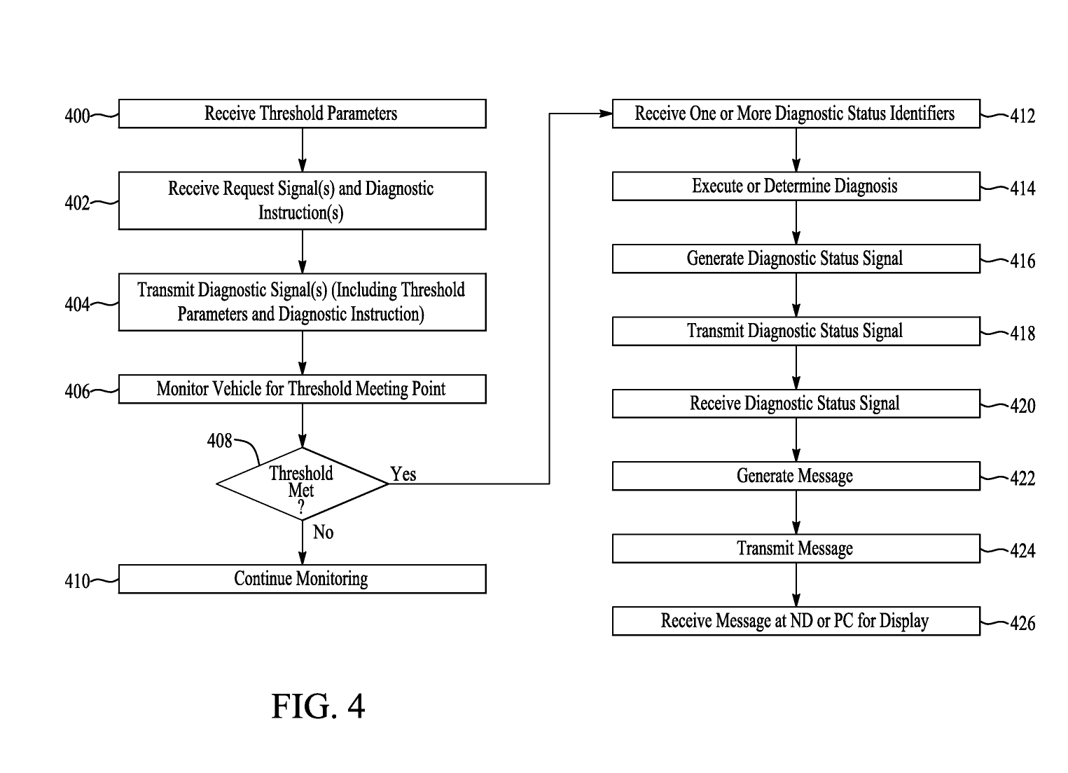

Non-limiting exemplary uses of the testing parameters will be described with respect to FIG. 4 and the following example. As illustrated in block 400, the parameter(s) may be stored in one or more of the server(s) 101, the remote terminals 103, 105, or the communication module 200. A non-limiting testing parameter may include, for example, an engine's revolutions per minute (RPMs).

A request signal may be received at server(s) 101, as illustrated in block 402, and transmitted to the cellular communication module 200 as illustrated in block 404. The cellular communication module 200 may stall execution of further diagnostic or service functions until the vehicle's engine reaches a predetermined RPM (e.g., below 300 RPMs). The predetermined RPM may be programmed to the server(s) 101 and, therefore, set in an algorithm transmitted with the signal to the communication module 200.

The cellular communication module 200 may be in communication with the vehicle data bus 213, 214 to monitor for when the threshold parameter is reached as illustrated in block 406. Accordingly, a determination is made as to whether the threshold has been met as illustrated in block 408. The cellular communication module 200 may monitor the vehicle data bus 213, 214 until it receives one or more signals indicating that the threshold is met as illustrated in block 410.

Upon reaching the threshold, execution of the diagnostic and service functions may continue by receiving diagnostic information from the powertrain as illustrated in block 412. In one embodiment, the diagnostic information may be also recorded to at least one of the cellular communication module 200, the server(s) 101, or the remote terminals 103, 105.

A diagnostic status of the powertrain may be determined by the cellular communication module (e.g., by the microprocessor 217) as illustrated in block 414. For example, the microprocessor 217 may receive one or more messages (e.g., and without limitation, DTCs) from the vehicle data bus and have computer-executable instructions for translating the vehicle-readable messages into messages useful for (or readable by) the nomadic device or computer. In one embodiment, the diagnostic status may be determined using a look-up table. A diagnostic status signal may be generated based upon the diagnostic status as illustrated in block 416 and transmitted to the server(s) 101 as illustrated in block 418.

The server(s) 101 may receive the diagnostic status signal as illustrated in block 420, generate a message with the diagnostic status of the engine (block 422) and transmit the message to the ND 103 and/or computer 105 (block 424). The result signal may then be received by the ND 103 and/or computer 105 including a message for display as illustrated in block 426. In one embodiment, the message may include a warranty status of the vehicle based on information stored in the server(s) 101.

Accordingly, in at least one way, a diagnosis of the vehicle can be made while the vehicle owner/driver is driving or travelling. Additionally, the diagnosis can be made without having the vehicle owner/driver visit the dealership or a service shop.

Another non-limiting example of a testing parameter may include the temperature inside the vehicle 121 (e.g., based on ambient temperature). In this non-limiting environment, an OEM (e.g., product development) may learn that in certain vehicles, when the outside temperature is at a certain level, a vehicle's air conditioning system turns off or does not produce cool air. Accordingly, using one or more embodiments described above, based on the parameter(s), the vehicle's temperature may be monitored for when it reaches a level higher than ambient temperature. Once the vehicle cabin is at an ambient temperature, the vehicle may begin collecting data from the air conditioning system and transmit it back to the ND 103 and/or computer 105. Thus, in at least one way, an OEM can resolve the problem without having to issue vehicle recalls. Further details of how data is collected from the vehicle will be further described below. Other non-limiting example may include atmospheric temperature and a vehicle's speed.

The parameter(s) may or may not be user defined. Additionally, the parameter(s) may be benchmark parameters. The parameter(s) may identify a threshold level for activating one or more service or engineering functions. Accordingly, upon reaching the threshold, the recording and/or collecting of diagnostic information from one or more vehicle components may commence.

In FIG. 3, a determination may be made at the server(s) 101 if the user has any personal preferences as illustrated in block 306. A non-limiting example of a personal preference may include predetermined times (e.g., weekly, monthly, yearly, or on specific dates) when an OEM may upload DTCs and/or other vehicle information to the server(s) 101. In at least one way, this preference may provide implicit authorization to an OEM to upload this information thereby satisfying privacy concerns that may arise from vehicle owners. While the preferences may be stored elsewhere, for purposes of illustration, FIG. 3 illustrates the operation based on the personal preferences being stored on the server(s) 101.

The personal preferences may be stored on the server(s) 101. Alternatively or additionally, the personal preferences may be stored in the ND's 103 or computer's 105 memory (not shown). In yet another embodiment, the personal preferences may be stored at the vehicle (e.g., on the SIM card 221, on the microprocessor 217 of the cellular communication module 200, or in a memory module present elsewhere in the vehicle). In this latter embodiment, the server(s) 101 may route the data packets to the vehicle without further processing.

Referring back to FIG. 3, if the user has personal preferences associated with one or more vehicle components, the server(s) 101 may receive instructions to access the stored preferences as illustrated in block 308. In one embodiment, the instructions may be transmitted with the one or more data packets received from the ND 103 and/or computer 105. The server(s) 101 may extract or read these instructions from the data packets to retrieve the stored personal preferences.

In one embodiment, a further determination may be made at server(s) 101 as to whether a personal identification number (PIN) is required to access the personal preferences or to engage one or more of the service and engineering functions as illustrated in block 312. The PIN may be stored at server(s) 101 or may be transmitted with the data packets transmitted from the ND 103 and/or the computer 105. If a PIN is required, the server(s) 101 may transmit a request for the PIN as illustrated in block 314. The request may be transmitted to one or more memory locations (e.g., a database) on the server(s) 101 or to the remote terminals 103, 105. The PIN may be retrieved from the server(s) 101 using, for example, a look-up table based on information such as VIN, a customer number, a MIN, or other non-limiting identifiers. It should be understood that the PIN may be retrieved in any other means known in the art and the previous example is illustrative.

The server(s) 101 may receive the PIN as illustrated in block 316. The PIN may then be validated as illustrated in block 318. If the PIN is not correct, the server(s) 101 may re-transmit the request as represented by loop 320. In one embodiment, a user may reenter a PIN a predetermined number of times (e.g., 3 or 5 times) after entering an incorrect PIN. If the PIN is correct, the server(s) 101 may retrieve the personal preferences associated with the request, as illustrated in block 322, and transmit the one or more data packets with the stored preferences to the cellular communication module as illustrated in block 310.

If a PIN is not required to access the personal preferences or if there are no stored preferences, upon receiving the one or more data packets, the server(s) 101 may transmit the one or more data packets to the cellular communication module as represented in block 310. The one or more data packets may be transmitted over the network (e.g., cellular network 113 or the internet). The cellular communication module 200 may then receive (e.g., via cellular antenna 201) the one or more data packets over the network as represented in block 326. The microprocessor 217 may listen for and/or transmit signals from/to the vehicle network 214 as represented in block 330. In one embodiment, the one or more signals may be decoded and translated at the microprocessor 217 for communication with the vehicle data bus (e.g., CAN transceiver 213 and vehicle network 214) as represented in block 328. The data packets (including the instructions) may be received and decoded by the cellular communication module 200 so that the data packets may be transmitted to one or more vehicle components.

After one or more operations have been completed based on the request/command by the user (for example, and without limitation, all DTCs and/or customer usage profiles have been collected), the microprocessor 217 may receive one or more result signals through communication with the vehicle data bus (e.g., the CAN transceiver 213) as illustrated in block 332. The microprocessor 217 may extract one or more return data packets for transmission to the ND 103 and/or computer 105 as in block 334. Transmission may be accomplished by the cellular antenna 201 over network 115. Furthermore, the microprocessor 217 may process the return data packets for interpretation by the server(s) 101 and/or the remote terminal 103, 105. This processing may occur, for example, using a look-up table.

The result signals (including the results data packets) may include a result of the requested operation. For example, the result signals may include the DTCs gathered from the one or more vehicle components. As another non-limiting example, the result signal(s) may include the customer usage profiles. For example, the result signal(s) may include one or more monitor completion rates of an OBD II or the temperature of the catalyst. In one or more embodiments, customer usage profiles may provide insight into the driving habits of the person driving the vehicle.

The result signal(s) may further include a notification that the data from the vehicle components were successfully or unsuccessfully collected.

The data packets may be transmitted to the remote terminals 103 and/or 105 as illustrated in block 336. In one embodiment, the return data packets may be routed through server(s) 101, as illustrated in block 338, which may or may not further process the data packets for transmission to the remote terminals 103 and/or 105. The result data packet(s) may be transmitted to (as illustrated in block 340) and received by the ND 103 and/or computer 105.

For example, the server(s) 101 may receive the results signal(s) including the DTCs and look up this information in a database table (not shown) in the server(s) 101 to access customer warranty information, maintenance records, and other non-limiting information. Alternatively or additionally, the server(s) 101 may access information pertaining to the meaning of one or more trouble codes based on the DTCs received in the result signal(s). Thus, in certain environments, the definition of various trouble codes may assist to define those codes that do not have a warning light or message associated with it. The DTCs may or may not be proprietary.

Based on the data gathered from the vehicle, a report may be generated and displayed to the user at the ND 103 and/or computer 105 as illustrated in block 342. The report may be generated each time the user requests one or more operations. Alternatively or additionally, the report may be generated at predetermined time intervals or according to a user preference (e.g., on a monthly basis or each time the user specifically requests a report). A report may include, but is not limited to, an electronic mail message or a text message.

The report may include information such as (without limitation) whether the vehicle is still under warranty, OBD II monitor completion rates, results of durability testing, and standardized and non-standardized diagnostic trouble codes.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed:

1. A computer-implemented method for remotely performing one or more vehicle service functions, the method comprising:
receiving at a computer a first signal including at least one instruction for performing a diagnosis of one or more vehicle components;
retrieving one or more threshold parameters for determining a diagnosis of the one or more vehicle components;
transmitting a diagnostic signal to a vehicle receiver together with the one or more threshold parameters and the at least one diagnostic instruction, wherein a determination as to whether the one or more threshold parameters has been met is made at a vehicle;
if the one or more threshold parameters are met, receiving at least one second signal including one or more diagnostic status identifiers identifying a diagnostic status of the one or more vehicle components;
generating a message including at least one diagnostic status of the one or more vehicle components based on the one or more diagnostic status identifiers; and
displaying the message on a graphical display for vehicle diagnosis and service.

2. The computer-implemented method of claim 1 further comprising, if the one or more threshold parameters are met:
receiving vehicle component usage data based on the one or more diagnostic status identifiers;
determining a usage of the one or more vehicle components based on the vehicle component usage data.

3. The computer-implemented method of claim 2 further comprising generating one or more customer vehicle usage profiles based on the vehicle usage data.

4. The computer-implemented method of claim 1 wherein the one or more threshold parameters is user-defined.

5. The computer-implemented method of claim 1 wherein at least one threshold parameter relates to a vehicle engine.

6. The computer-implemented method of claim 1 wherein the at least one threshold parameter relates to a temperature of a vehicle or the one or more vehicle components.

7. The computer-implemented method of claim 1 wherein the at least one diagnostic instruction includes at least one instruction for receiving diagnostic trouble codes (DTC) and the one or more diagnostic status identifiers are one or more DTCs.

8. The computer-implemented method of claim 7 wherein the DTCs include non-standardized DTCs.

9. The computer-implemented method of claim 1 further comprising, upon receiving the second signal:
retrieving warranty information for one or more vehicles;
determining if the one or more vehicles is under warranty; and
based on the determination, displaying a warranty status with the message.

10. A cellular communication module within a vehicle for remotely performing one or more vehicle service functions, the cellular communication module being configured to:
receive at least one diagnostic signal including one or more threshold parameters and at least one instruction for determining a diagnosis of one or more vehicle components;
communicate with a vehicle data bus to monitor for when the one or more threshold parameters are met;
if the one or more threshold parameters are met, capture one or more diagnostic status identifiers;
determine a diagnostic status based on the one or more diagnostic status identifiers; and
transmit a diagnostic status signal based on the diagnostic status to a remote terminal for vehicle diagnosis and service.

11. The cellular communication module of claim 10 further configured to determine the diagnosis while a vehicle is travelling.

12. The cellular communication module of claim 11 wherein at least one threshold parameter relates to a speed of the vehicle.

13. The cellular communication module of claim 10 wherein the at least one threshold parameter relates to atmospheric temperature.

14. The cellular communication module of claim 10 wherein the one or more diagnostic status identifiers are one or more diagnostic trouble codes.

15. The computer-implemented method of claim 10 wherein the one or more threshold parameters is user-defined.

16. The cellular communication module of claim 10 wherein the one or more diagnostic status identifiers are first diagnostic status identifiers and the cellular communication module is further configured to:
retrieve one or more second diagnostic status identifiers;
process the one or more first diagnostic status identifiers based on the one or more second diagnostic status identifiers; and
determine the diagnostic status based on the process function.

17. The cellular communication module of claim 16 wherein the cellular communication module is configured to determine the diagnostic status based on the process function in order to generate a diagnostic status capable of being displayed on the remote terminal.

18. The cellular communication module of claim 10 wherein the remote terminal is a nomadic wireless communication device or a personal computer.

19. A computer-implemented method for remotely performing one or more vehicle service functions, the method comprising:
receiving at least one diagnostic signal including one or more threshold parameters and at least one instruction for determining a diagnosis of one or more vehicle components;
communicating with a vehicle data bus to monitor for when the one or more threshold parameters are met;
if the one or more threshold parameters are met, capturing one or more diagnostic status identifiers;
determining a diagnostic status based on the one or more diagnostic status identifiers; and
transmitting a diagnostic status signal based on the diagnostic status to a remote terminal for vehicle diagnosis and service.

20. The computer-implemented method of claim 19 further comprising determining the diagnostic status while a vehicle is travelling.
